(19) United States
(12) Patent Application Publication
(10) Pub. No.: US 2026/0119990 A1
(43) Pub. Date: Apr. 30, 2026

(54) DEVICE AND METHOD WITH MODEL SELECTION

(71) Applicant: SAMSUNG ELECTRONICS CO., LTD., Suwon-si (KR)

(72) Inventors: Saehyun AHN, Suwon-si (KR); Kikyung KIM, Suwon-si (KR); Chanho AHN, Suwon-si (KR)

(73) Assignee: SAMSUNG ELECTRONICS CO., LTD., Suwon-si (KR)

(21) Appl. No.: 19/366,755

(22) Filed: Oct. 23, 2025

(30) Foreign Application Priority Data
Oct. 31, 2024 (KR) 10-2024-0152766

(51) Int. Cl. G06N 20/00

(52) U.S. Cl. CPC G06N 20/00

(57) ABSTRACT

A method and device with model selection are provided. The method includes identifying one or more models trained using a first data set, the first data set associated with a source domain and a second data set associated with a target domain, for each of the one or more models, acquiring at least one first feature corresponding to at least one piece of first data from the first data set and acquiring at least one second feature corresponding to at least one piece of second data from the second data set, acquiring, based on the at least one first feature, at least one third feature with a set dimension corresponding to the at least one second feature, and selecting a target model from the one or more models based on a first score calculated using the at least one first feature and the at least one third feature.

### CROSS-REFERENCE TO RELATED APPLICATIONS

This application claims the benefit of Korean Patent Application No. 10-2024-0152766, filed on Oct. 31, 2024, in the Korean Intellectual Property Office, the disclosure of which is incorporated herein by reference in its entirety.

### BACKGROUND

### 1. Field

The present disclosure relates to a device and method with model selection.

### 2. Description of Related Art

Models trained based on a large amount of datasets may be publicly disclosed for use across various domains. In this context, benchmark scores indicating model performance may also be made publicly available. Generally, models with high benchmark scores demonstrate strong performance across different tasks and domains.

However, not all models are suitable for tasks in a predetermined domain. In particular, models with high benchmark scores may not necessarily perform well on such tasks. In this regard, there is a need for a method for selecting a model from among pre-trained models that is suitable for a predetermined domain, as well as a device that is capable of executing the model selection method.

### SUMMARY

In one general aspect, a method for selecting a model in an electronic device includes identifying one or more models trained using a first data set, the first data set associated with a source domain and a second data set associated with a target domain; for each of the one or more models, acquiring at least one first feature corresponding to at least one piece of first data from the first data set and acquiring at least one second feature corresponding to at least one piece of second data from the second data set; acquiring, based on the at least one first feature, at least one third feature with a set dimension corresponding to the at least one second feature; and selecting a target model from the one or more models based on a first score calculated using the at least one first feature and the at least one third feature.

In one general aspect, a non-transitory computer-readable recording medium may store a program executable by a computer to perform the method described herein.

In one general aspect, an electronic device for selecting a model includes one or more processors; and a memory storing instructions that, when executed by the one or more processors, configures the one or more processors to identify one or more models trained using a first data set associated with a source domain and a second data set associated with a target domain; for each of the one or more models, acquire at least one first feature corresponding to at least one piece of first data from the first data set and acquire at least one second feature corresponding to at least one piece of second data from the second data set; acquire, based on the at least one first feature, at least one third feature with a set dimension corresponding to the at least one second feature; and select a target model from the one or more models based on a first score calculated using the at least one first feature and the at least one third feature.

In one general aspect, a method for selecting a model in an electronic device includes identifying task information on a task to be performed at a user terminal and resource information on a resource available in the user terminal; determining, based on the task information and the resource information, one or more models in a model set formed of models trained based on a first data set associated with a source domain; identifying the first data set and a second data set associated with a target domain, wherein the first data set includes first unlabeled data from the source domain and the second data set includes second unlabeled data from the target domain; and selecting a target model from the one or more models based on the first unlabeled data and the second unlabeled data.

According to example embodiments, an electronic device may efficiently select a model suitable for a task associated with a predetermined domain. Particularly, since an additional training process is not accompanied for selection of the model, a resource and a time required for selecting the model may be minimized.

Other features and aspects will be apparent from the following detailed description, the drawings, and the claims.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates an electronic device according to one or more embodiments;

FIG. 2 is a flowchart illustrating a model selection method of an electronic device according to one or more embodiments;

FIG. 3 is a flowchart illustrating a model selection method of an electronic device in further detail according to one or more embodiments;

FIG. 4 illustrates a method of tuning a target model so that the target model is additionally trained to be a model suitable for a predetermined domain according to one or more embodiments;

FIG. 5 is a flowchart illustrating a method of determining a candidate model set based on task information on a task to be performed at a user terminal and resource information on a resource available in the user terminal according to one or more embodiments; and

FIG. 6 is a graph illustrating a time required for selecting a model based on a model selection method according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

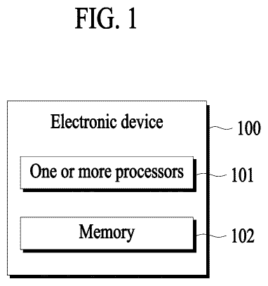

FIG. 1 illustrates an electronic device according to one or more embodiments.

Referring to FIG. 1, an electronic device 100 may include one or more processors 101 and a memory 102. With respect to the electronic device 100 which is illustrated in FIG. 1, only elements associated with the present example embodiment are illustrated. Thus, those skilled in the art associated with the present example embodiment may understand that additional elements in general use may be incorporated without departing from the scope of the disclosure.

The one or more processors 101 may control overall operations of the electronic device 100. Each processor 101 includes processing circuitry. In one example, each processor 101 may be implemented as at least one hardware unit. In addition, the one or more processors 101 may execute one or more software modules by processing instructions (e.g., executable code) stored in the memory 102. In various embodiments, the one or more processors 101 may control operations performed by the electronic device 100 through interaction with the memory 102 and any other elements included in the electronic device 100.

In one embodiment, the processor 101 may identify one or more models trained using a first data set associated with a source domain, and a second data set associated with a target domain. For each identified model, the processor 101 may extract/acquire at least one first feature corresponding to an element of first data included in the first data set and acquire at least one second feature corresponding to an element of second data included in the second data set based on the extracted first feature, the processor 101 may derive at least one third feature having a predetermined dimension corresponding to the second feature, and select a target model from the one or more models based on a first score computed/calculated based on the first and third features.

In one embodiment, each model may be a pre-trained model that has been initially trained based on a large amount of data. More specifically, each model may be trained on the large amount of data by utilizing a large amount of computational resources (e.g., resources of 10,000 graphics processing unit (GPU) hours or more). In addition, the one or more models may be publicly available models, with the electronic device 100 obtaining model information from an external server.

In one embodiment, the first data set may include leaning data used to train the models. Although the data included in the first data set may be unlabeled, this is provided solely as an example. The first data set may be data on the source domain.

Similarly, the second data set may include leaning data associated with the target domain. Unlike the first data set, the data included in the second data set may not be used to pre-train the models. The second dataset may also comprise unlabeled data, provided solely as an example.

Here, the target domain refers to a specific field of a task for which the finally trained target model is intended to be used. In cases where the target domain comprises nonpublic data, substantial differences in data format between the source domain and the target data may exist, thereby enhancing the benefit of selecting a model expected to perform well on a task of the target domain. In one embodiment, the target domain may pertain to the semiconductor or medical fields; such examples are provided merely for illustrative purposes.

The target model is defined as a model identified as being suitable for a task associated with the target domain among the plurality of models. Here, the term “task” refers to any of the various operations or applications that may be performed using the model.

The memory 102 may store the one or more instructions (e.g., executable code) that are executed by the one or more processors 101. The memory 102 may be referred to as a storage that can be volatile or non-volatile. The memory 102 may hold information/data necessary for performing a model selection method, such as information/data pertaining to the models, the first data set, and the second data set.

In one embodiment, the second data set may include the unlabeled data. In practical scenarios where obtaining labeled data is difficult, the model selection method may be applied to the target domain using the second data set composed of the unlabeled data. Also, since only the first score is computed/calculated for model selection, and the model selection method does not require an additional training process, the computational resources and time required for model selection may be minimized.

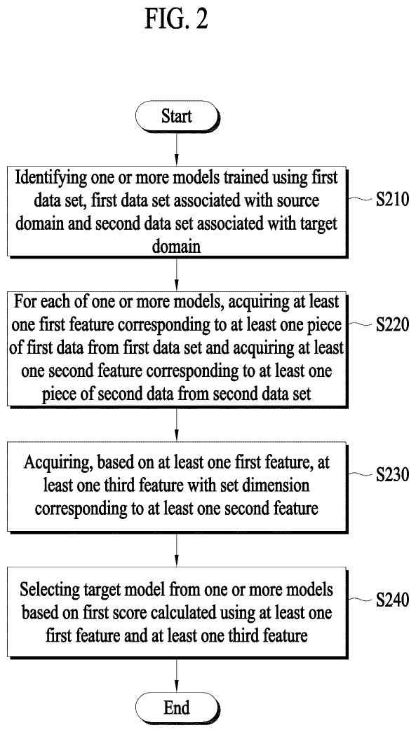

FIG. 2 is a flowchart illustrating a model selection method of an electronic device according to one or more embodiments.

Referring to FIG. 2, it is apparent that certain operations of the model selection method implemented by the electronic device may be modified, substituted, or rearranged within a scope readily understood by those skilled in the art without departing from the disclosed embodiments.

In operation S210, the electronic device 100 may identify one or more models trained using a first data set, the first data set associated with a source domain and a second data set associated with a target domain.

In one embodiment, the one or more models may be candidate models determined to be suitable for performing a task associated with the target domain among the plurality of models included in a model set. Here, each model in the model set may be a pre-trained model. However, not all the models may exhibit superior performance for the task associated with the target domain. Accordingly, a candidate model may be selected through a primary filtering process based on scores showing benchmark performance of the models and a variety of information including information on resources to be required for training the models. For example, the candidate model may be one for which a score showing benchmark performance is greater than or equal to a predetermined threshold or a set value; this threshold or set value is provided solely for illustrative purposes.

In one embodiment, the electronic device 100 may determine, for each model in the model set, a performance score calculated using the first data set, and retrieve/identify information on a resource required for training the each model. Based on this performance score and resource information, the electronic device 100 may select one or more candidate models from the model set. Here, the performance score of the model may include a benchmark score. By restricting the series of calculations for target model selection only to the candidate models rather than applying them to every model in the model set, the overall resource usage and processing time are minimized.

In one embodiment, the first data set may include at least one piece of first data from the source domain, and the second data set may include at least one piece of second data from the target domain. Here, the target domain may be a domain mainly formed of nonpublic data, such as a semiconductor domain or a medical domain, but it is merely an example. For example, the target domain may be a domain selected by a user of the electronic device 100 from a list of various available domains.

In operation S220, for each of the one or more models, the electronic device 100 may acquire at least one first feature corresponding to the at least one piece of first data from the first data set, and acquire the at least one second feature corresponding to the at least one piece of second data from the second data set.

In one embodiment, the electronic device 100 may extract the at least one first feature and the at least one second feature using a feature extraction function for a corresponding model (e.g., Mᵢ that is an i-th model). Each of the at least one first feature and the at least one second feature may be data represented as a vector characterizing a feature of sample data.

In operation S230, the electronic device 100 may acquire, based on the at least one first feature, at least one third feature with a set dimension corresponding to the at least one second feature.

Some features of the at least one second feature may exhibit a low diversity. A feature exhibiting a high diversity among the at least one second feature may be a feature properly reflecting major information on the at least one first feature associated with the source domain. That is, calculating the first score by extracting the feature having the high diversity among the at least one second feature may be further appropriate. In the present disclosure, each of the at least one third feature may be referred to as a major feature. In other words, despite significant difference between the target domain and the source domain, an operation of extracting the major feature from the at least one second feature enables the electronic device 100 to effectively determine the optimal target model among the one or more models.

In one embodiment, the electronic device 100 may acquire the at least one third feature having the set dimension corresponding to the at least one second feature by applying a principal component analysis (PCA) to a matrix formed of the at least one first feature. More specifically, the PCA facilitates dimensionality reduction while maintaining major information on data and includes an operation of projecting so that variation of the data is maximized. In this regard, the electronic device 100 may identify a set number of unique values corresponding to the set dimension among the unique values calculated based on the at least one first feature and identify at least one unique vector corresponding to at least one unique value. Afterward, the electronic device 100 may acquire the at least one third feature by projecting each of the at least one second feature onto the at least one unique vector.

However, the at least one third feature is calculated not only through the PCA. For example, the electronic device 100 may acquire the at least one third feature by using an artificial intelligence model for extracting the major feature.

In operation S240, the electronic device 100 may select a target model from the one or more models based on the calculated first score using the at least one first feature and the at least one third feature.

In one embodiment, the electronic device 100 may calculate, using a predetermined diversity calculation, a value representing a degree of excellence of an expression capability of a model i in a domain. Here, a higher value indicates that features for the model i in the domain are more distinguishable from each other. In other words, as the diversity of the features for the model i increases, the calculated value also increases. Features distinguished from each other may have different sizes and directions, enabling differentiation between two distinct pieces of sample data.

In one embodiment, the electronic device 100 may calculate, using the predetermined diversity calculation, a first value representing a diversity of the at least one first feature and a second value representing a diversity of the at least one third feature. That is, the first value may be a value representing the degree of excellence of the expression capability of the model i in the source domain, and the second value may be a value representing the degree of excellence of the expression capability of the model i in the target domain.

In one embodiment, the electronic device 100 may calculate the first score based on the first and second values. The first score may be derived by dividing the second value by the first value and represent the degree of excellence of the expression capability of the model i in the target domain in comparison with the degree of excellence of the expression capability of the model i in the source domain. That is, a model exhibiting a relatively superior expression capability in the target domain relative to other models with similar expression capabilities in the source domain may yield a higher first score. As described, since the one or more models are the candidate models identified as being suitable for performing the task associated with the target domain, the first value of each model may be calculated to be similar to another within a set range.

In one embodiment, the electronic device 100 may select the target model from the candidate models based on their respective first scores. More specifically, the electronic device 100 may determine a model with the highest first score among the candidate models as the target model.

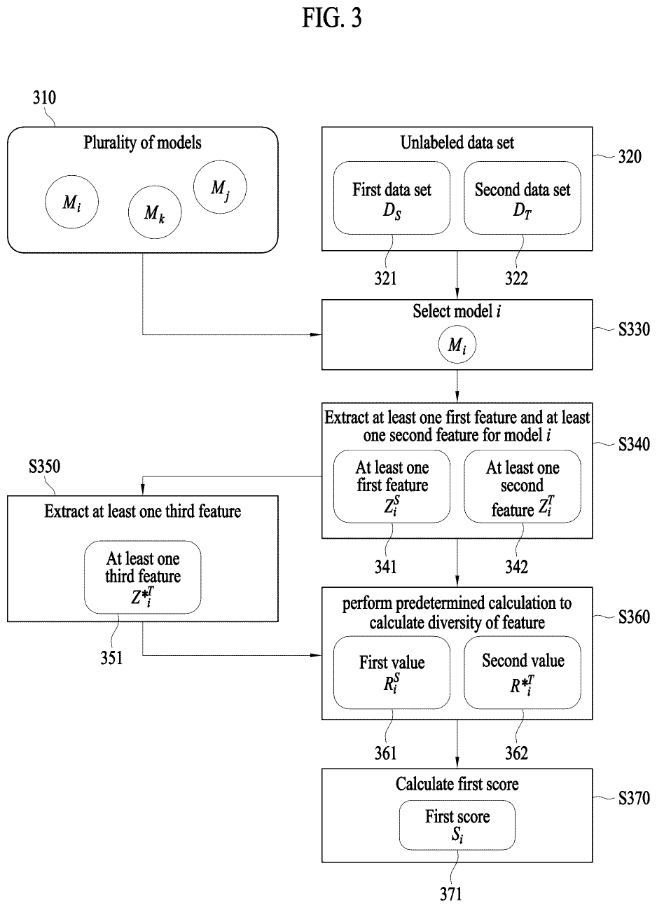

FIG. 3 is a flowchart illustrating a model selection method of an electronic device in further detail according to one or more embodiments.

A plurality of models 310 may include a candidate model identified as being suitable for performing a task associated with the target domain among models included in a model set. Referring to FIG. 3, the plurality of models 310 may include three models that are Mᵢ, Mₖ, and Mⱼ, but it is merely an example.

An unlabeled data set 320 may include a first data set 321 and a second data set 322. The first data set 321 may be a data set associated with a source domain, and the second data set 322 may be a data set associated with a target domain.

Referring to the following Equation 1, the first data set 321 may be denoted by D_{S} and formed of

$${x}_{n}^{s}$$

that is data of the source domain.

$${x}_{n}^{s}$$

may be n-th sample data included in the first data set 321.

$${D}_{S} = {\{ {x}_{n}^{s} \}}_{n = 1}^{{N}_{s}} \qquad Equation 1$$

Referring to the following Equation 2, the second data set 322 may be denoted by DT and formed of

$${x}_{n}^{T}$$

that is data of the target domain.

$${x}_{n}^{T}$$

may be n-th sample data included in the second data set 322.

$${D}_{T} = {\{ {x}_{n}^{T} \}}_{n = 1}^{{N}_{T}} \qquad Equation 2$$

As described above, operation S220 of acquiring at least one first feature, operation S220 of acquiring at least one second feature, operation S230 of acquiring at least one third feature, and operation S240 of calculating a first score may be performed for each of the one or more models. In this regard, a detailed method of calculating the first score for Mᵢ that is the model i among the plurality of models 310 will be described with reference to FIG. 3. In this regard, the electronic device 100 may select Mᵢ that is the model i in operation S330.

In operation S340, the electronic device 100 may extract at least one first feature 341 and at least one second feature 342 for the model i.

Referring to the following Equation 3, the at least one first feature 341 may be extracted using a feature extraction function corresponding to the model i.

$${x}_{n}^{s}$$

may be the n-th sample data included in the first data set 321, and f_{M}_{ᵢ} may be the feature extraction function corresponding to the model i.

$${z}_{n , i}^{S}$$

may be a first feature that corresponds to the n-th sample data included in the first data set 321 and is calculated using f_{M}_{ᵢ} that is the feature extraction function.

$${Z}_{i}^{S}$$

may be a matrix formed of

$${z}_{n , i}^{S}$$

which denotes first to N_{S}-th first features and may be referred to as a first feature set.

$${z}_{n , i}^{S} = {f}_{{M}_{i}} ( {x}_{n}^{s} ) \qquad Equation 3$$

Referring to the following Equation 4, the at least one second feature 342 may be extracted using the feature extraction function corresponding to the model i.

$${x}_{n}^{T}$$

may be the n-th sample data included in the second data set 322, and f_{M}_{ᵢ} may be the feature extraction function corresponding to the model i.

$${z}_{n , i}^{T}$$

may be a second feature that corresponds to the n-th sample data included in the second data set 322 and is calculated using the feature extraction function,

$${f}_{{M}_{i}} \cdot {Z}_{i}^{T}$$

may be a matrix formed of

$${z}_{n , i}^{T}$$

which denotes first to N_{T}-th second features and may be referred to as a second feature set.

$${z}_{n , i}^{T} = {f}_{{M}_{i}} ( {x}_{n}^{T} ) \qquad Equation 4$$

In operation S350, the electronic device 100 may extract at least one third feature 351. Particularly, since diversities of some features of the at least one second feature 342 are low due to significant difference between the data of the target domain and the data of the source domain, an operation of extracting the at least one third feature 351 from the at least one second feature 342 needs to be performed.

In one embodiment, the electronic device 100 may extract the at least one third feature 351 by applying a PCA to a matrix formed of the at least one first feature 341. Referring to the following Equation 5, the at least one third feature 351 may be identified using h(⋅) that is a feature extraction function associated with the PCA.

$${Z}_{i}^{* T}$$

may be a third feature set formed or the at least one third feature 351.

$${Z}_{i}^{* T} = h ( {Z}_{i}^{T} ) \qquad Equation 5$$

More specifically, the electronic device 100 may identify a set number of unique values corresponding to a set dimension among the unique values calculated based on the first feature set which is a matrix formed of the at least one first feature 341 and identify at least one unique vector corresponding to at least one unique value. Here, the set number of unique values may include a set number of unique values having large values among the unique values calculated based on the matrix,

$${Z}_{i}^{S}$$

in other words, the at least one unique vector may be a unique vector that is an axis maximizing variation of data. In this regard, the at least one third feature 351 which is acquired as each of the at least one second feature 342 is projected onto the at least one vector may be data of which a dimension is reduced while major information is maintained.

Referring to the following Equation 6, the at least one third feature 351 may be identified the following Equation 6.

$${Z}_{i}^{T}$$

may be the second feature set, and

$$EV ( {Z}_{i}^{S} , n )$$

may be a function for extracting at least one unique vector corresponding to n (n is a set number) unique values having large values among the unique values calculated based on

$${Z}_{i}^{S} .$$

### Also,

$$Proj ( {Z}_{i}^{T} , EV ( {Z}_{i}^{S} , n )$$

may be a function for extracting, by projecting each of the at least one second feature 342 included in the second feature set onto the at least one extracted unique vector, the at least one third feature 351 which has the set dimension.

$${Z}_{i}^{* T} = h ( {Z}_{i}^{T} ) = Proj ( {Z}_{i}^{T} , EV ( {Z}_{i}^{S} , n ) \qquad Equation 6$$

In one embodiment, the set dimension may be determined based on a similarity between the source domain and the target domain. As an example, when the similarity between the source domain and the target domain is less than or equal to a set first degree, the set dimension may be set to be smaller than a set first value. In this regard, minor information on the second feature may be attenuated, and major information on the second feature may be maximally maintained. As another example, when the similarity between the source domain and the target domain is greater than or equal to a set second degree, the set dimension may be set to be larger than a set second value. In this regard, most information included in the second feature of the target domain may be maximally maintained.

In operation S360, the electronic device 100 may perform predetermined calculation to calculate a diversity of a feature.

In one embodiment, the electronic device 100 may calculate a first value representing a diversity of the at least one first feature 341 and a second value representing a diversity of the at least one third feature 351. Referring to the following Equation 7, a value representing the diversity of the feature may be calculated using g(⋅) that is a function for calculating a degree of excellence of an expression capability of the model i.

$${R}_{i}^{S}$$

may be a first value 361 representing the diversity of the at least one first feature 341, and

$${R}_{i}^{* T}$$

may be a second value 362 representing the diversity of the at least one third feature 351.

$${R}_{i}^{S} = g ( {Z}_{i}^{S} ) , {R}_{i}^{* T} = g ( {Z}_{i}^{* T} ) \qquad Equation 7$$

In one embodiment, g(⋅) which is a function for calculating a degree of excellence of an expression capability of a model may be calculation for variation of a matrix. At this point, the first value may be variation of the matrix formed of the at least one first feature, and the second value may be variation of a matrix formed of the at least one third feature. The variation of the matrix may tend to be calculated to be large as features included in the matrix become distinguishable. In other words, a large value calculated using g(⋅) may show that the features greatly tend to be distinguished.

In operation S370, the electronic device 100 may extract the first score.

Referring to the following Equation 8, Si that is a first score 371 may be calculated based on

$${R}_{i}^{S}$$

that is the first value 361 and

$${R}_{i}^{* T}$$

that is the second value 362. More specifically, the first score 371 may be a value obtained by dividing

$${R}_{i}^{* T}$$

that is the second value 362 by

$${R}_{i}^{S}$$

that is the first value 361. That is, the first score 371 may represent the degree of excellence of the expression capability of the model i in the target domain in comparison with the expression capability of the model i in the source domain. Thus, a model having a highest first score may be selected, as a target model most suitable for the task associated with target domain, from the least one model.

$${S}_{i} = \frac{{R}_{i}^{* T}}{{R}_{i}^{S}} \qquad Equation 8$$

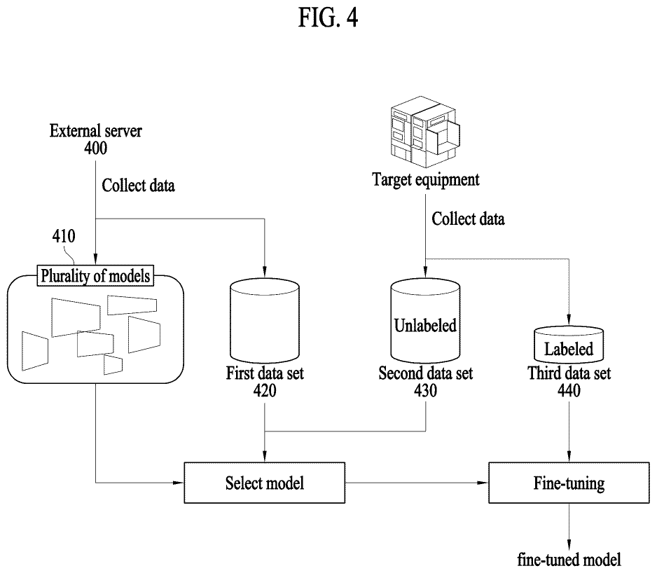

FIG. 4 is a diagram illustrating a method of tuning a target model so that the target model is additionally trained to be a model suitable for a predetermined domain according to one or more embodiments.

In one embodiment, the electronic device 100 may collect data from an external server 400. More specifically, the electronic device 100 may acquire a plurality of models 410 and a first data set 420 used to train the plurality of models 410.

In one embodiment, the electronic device 100 may collect the data from a target equipment (e.g., semiconductor equipment) associated with a target domain. More specifically, the electronic device 100 may acquire a second data set 430 comprising unlabeled data from the target domain and a third data set 440 comprising labeled data from the target domain.

As described in FIGS. 1 through 3, the electronic device 100 may select a target model from the plurality of models 410 by utilizing information from the first data set 420 and the third data set 440. Subsequently, the electronic device 100 may optimize the target model by tuning parameter(s) of the target model based on a data set of the target domain, thereby adapting the target model for a specific task of the target domain. Here, fine-tuning the parameter(s) of the target model based on the data set of the target domain may serve as additional training that renders the target model, which is initially trained based on the first data set 420, suitable for the target domain task.

In one embodiment, the electronic device 100 may fine-tune the parameter(s) of the target model based on the second data set 430; however, this is provided solely as an illustrative example. For example, as illustrated in FIG. 4, when the electronic device 100 acquires the third data set 440 comprising the labeled data of the target domain from a device associated with the target domain, the electronic device 100 may tune the parameter(s) of the target model based on the third data set 440. Although the third data set 440 includes only a small amount of the labeled data, performing fine-tuning on the target model that initially achieved the highest score may yield a final, fine-tuned model exhibiting excellent performance for the task associated with the target domain.

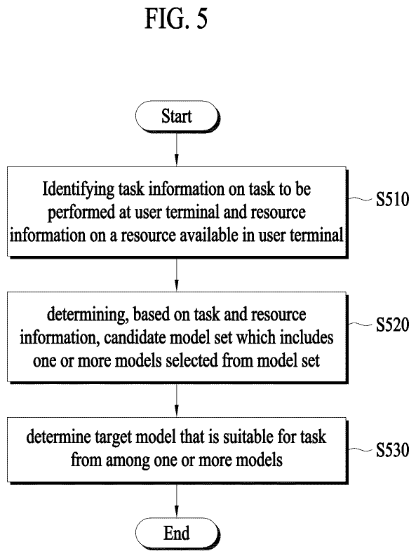

FIG. 5 is a flowchart illustrating a method of determining a candidate model set based on task information on a task to be performed at a user terminal and resource information on a resource available in the user terminal.

In operation S510, the electronic device 100 may identify the task information on the task to be performed at the user terminal and the information on the resource available at the terminal.

A target model selected in accordance with an example model selection method may be used for a task associated with a target domain; however, this is provided solely as an example. For example, the target model selected via the model selection method may be used for a task at the user terminal. In this context, the task information may include details regarding the required accuracy for the task, and the resource information may include details regarding a hardware resource (e.g., GPU) that is supportable on an hourly basis at the terminal.

In operation S520, based on the task and resource information, the electronic device 100 may determine a candidate model set which includes one or more models selected from a model set. Here, the one or more models in the candidate model set may correspond to the one or more models identified in operation S210.

In one embodiment, the electronic device 100 may identify, based on the task and resource information, a model suitable for performing the task among the models in the model set. More specifically, the electronic device 100 may select the one or more models based on performance scores of the models, information regarding the resources required for training the models, the task information, and the available resource information at the terminal. The electronic device 100 may select/identify the one or more models by performing a first comparison between the information on the task's required accuracy and the performance scores of the models and a second comparison between the information on the available hardware resource (e.g., the hourly supportable GPU capacity) and the information on the resource required for training the models. In other words, one identified model is expected to exhibit an accuracy higher than the required accuracy for the task among the models in the model set while being operable within the resource constraints supported by the terminal.

In operation S530, the electronic device 100 may determine the target model that is suitable for the task from among the one or more models (e.g., the candidate models of the candidate model set).

In one embodiment, the electronic device 100 may identify a first data set associated with a source domain and a second data set associated with the target domain. In this embodiment, the first data set may include first unlabeled data of the source domain, and the second data set may include second unlabeled data of the target domain.

In one embodiment, the electronic device 100 may select the target model from the one or more models (e.g., from the candidate models of the candidate model set) based on the first and second unlabeled data. Since the detailed method for determining the target model suitable for the task among the candidate models is similar to the aforementioned model selection method, a detailed description thereof is omitted.

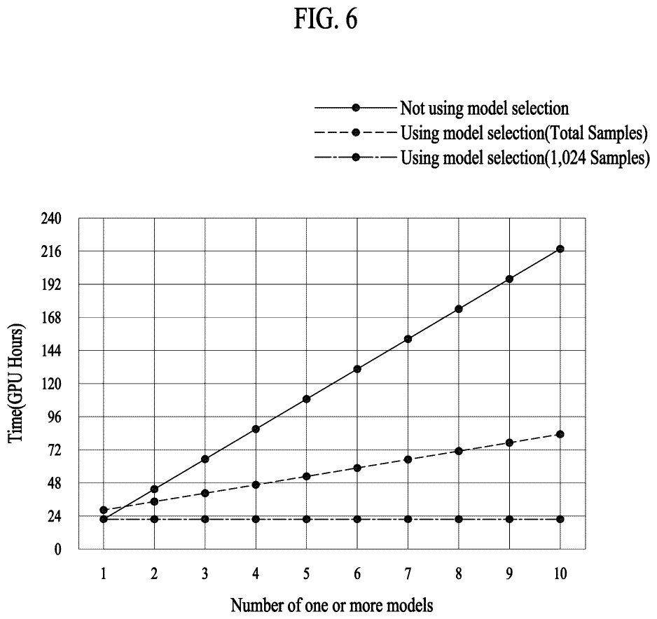

FIG. 6 is a graph illustrating a time required for selecting a model based on a model selection method according to one or more embodiments.

Referring to FIG. 6, the graph depicts the number of one or more models considered for selection on the x-axis and the time required to select a target model among the one or more models and fine-tune each model. In other words, the y-axis represents the total time required to generate a final version of the target model for a task associated with a target domain.

After fine-tuning is performed for each of the one or more models without using the model selection method, a model having most excellent performance may be determined to be the target model. The above-described method may be referred to as a first method. Referring to the following Equation 9, T₁ that is a time required according to the first method may be calculated by multiplying T_{tuning} that is a time required for the fine-tuning by M_{number} that is the number of the one or more models.

$${T}_{1} = {T}_{tuning} \times {M}_{number} \qquad Equation 9$$

However, T_{tuning} that is the time required for the fine-tuning may be greatly larger than T_{model selection} that is a time generally required for the model selection. In this regard, using the model selection method according to an example embodiment is further efficient in terms of a required resource and a required time.

While using the model selection method according to an example embodiment, the target model may be selected by using all sample data included in a first data set and a second data set, and the fine-tuning may be performed for the selected target model. The above-described method may be referred to as a second method. Referring to the following Equation 10, T₂ that is a time required according to the second method may be calculated based on T_{model selection} that is the time required for the model selection, M_{number} that is the number of the one or more models, and T_{tuning} that is the time required for the fine-tuning. More specifically, in the second method, the fine-tuning may be performed only for the target model. Since T_{model selection} that is the time required for the model selection is greatly smaller than T_{tuning} that is the time required for the fine-tuning, T₂ that is the time required according to the second method may be calculated to be smaller than T₁ that is the time required according to the first method.

$${T}_{2} = {T}_{model selection} \times {M}_{number} + {T}_{tuning} \qquad Equation 10$$

The first data set, comprised of data from a source domain, may include a large amount of data, and the second data set may also include a large amount of data. Consequently, extracting a feature by using only a subset of sample data from both the first and second data sets and then calculating a first score based on the extracted feature can be more efficient in terms of both the required resource and time than extracting the feature by using all sample data included in the first and second data sets and then calculating the first score based on the extracted feature.

In this context, the electronic device 100 may identify a set first number of data pieces from the first data set and identify a set second number of data pieces from the second data set. In other words, at least one piece of first data may include the set first number of data pieces from the first data set, and at least one piece of second data may include the set second number of data pieces from the second data set. Although the set first and second numbers may be equal, this is provided merely as an example.

While using the model selection method according to an example embodiment, the target model may be selected by using a portion of data pieces from the first and second data sets, and the fine-tuning may be performed for the selected target model. The above-described method may be referred to as a third method. Referring to the following Equation 11, T₃ that is a time required according to the third method may be calculated based on

$${T}_{model selection}^{*}$$

that is a time required for the model selection, M_{number} that is the number of the models, and T_{tuning} that is the time required for the fine-tuning. Since the third method is based on the portion of the data pieces from the first and second data sets,

$${T}_{model selection}^{*}$$

that is the time required for the model selection may be calculated to be smaller than T_{model selection} that is the time required for the model selection in the second method. Particularly, when both the first data set and the second data set include a large amount of data,

$${T}_{model selection}^{*}$$

that is the time required for the model selection may be calculated to be greatly smaller than T_{model selection} that is the time required for the model selection. That is, T₃ that is the time required according to the third method may be calculated to be smaller than T₂ that is the time required according to the second method.

$${T}_{3} = {T}_{model selection}^{*} \times {M}_{number} + {T}_{tuning} \qquad Equation 11$$

In other words, through the model selection method according to an example embodiment, the electronic device 100 may identify the target model that is most suitable in the target domain in a short time by consuming a small amount of resources. In addition, the final version of the target model that is fine-tuned may exhibit excellent performance for a task associated with a domain.

The electronic device 100 according to the above-described examples and embodiments may include a processor, a memory that stores and executes program data, a permanent storage such as a disk drive, a communication port for communicating with an external device, and a user interface device such as a touch panel, a key, and a button. Methods implemented by software modules or algorithms may be stored in a computer-readable recording medium as computer-readable code or program instructions executable in the processor. Here, the computer-readable recording medium may include a magnetic storage medium (e.g., a read-only memory (ROM), a random-access memory (RAM), a floppy disk, a hard disk, or the like), an optical reading medium (e.g., a CD-ROM or a digital versatile disc (DVD)), or the like. The computer-readable recording medium may be dispersed to computer systems connected by a network so that computer-readable codes may be stored and executed in a dispersed manner. The medium may be read by a computer, stored in the memory, and executed by the processor.

The examples and embodiments may be represented by functional blocks and various processing steps. These functional blocks may be implemented by various numbers of hardware and/or software configurations (e.g., as code/instructions) that execute specific functions. For example, the present example embodiments may adopt integrated circuit configurations such as a memory, a processor, a logic circuit, and a look-up table that may execute various functions by control of one or more microprocessors or other control devices. Similarly to that elements may be executed by software programming or software elements, the present example embodiments may be implemented by programming or scripting languages such as C, C++, Java, and assembler language, including various algorithms implemented by combinations of data structures, processes, routines, or of other programming configurations. Functional aspects may be implemented by algorithms executed by one or more processors. In addition, the present example embodiments may adopt the related art for electronic environment setting, signal processing, and/or data processing, for example.

The computing apparatuses, the electronic devices, the processors, the memories, the information output system and hardware, the storage devices, and other apparatuses, devices, units, modules, and components described herein with respect to FIGS. 1-6 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RW, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method for selecting a model in an electronic device, the method comprising:
identifying one or more models trained using a first data set, the first data set associated with a source domain and a second data set associated with a target domain;
for each of the one or more models, acquiring at least one first feature corresponding to at least one piece of first data from the first data set and acquiring at least one second feature corresponding to at least one piece of second data from the second data set;
acquiring, based on the at least one first feature, at least one third feature with a set dimension corresponding to the at least one second feature; and
selecting a target model from the one or more models based on a first score calculated using the at least one first feature and the at least one third feature.

2. The method of claim 1, wherein the acquiring of the at least one third feature comprises performing a principal component analysis on a matrix formed of the at least one first feature.

3. The method of claim 2, wherein the acquiring of the at least one third feature comprises:
identifying a set number of at least one unique value corresponding to the set dimension among unique values computed based on the matrix;
identifying at least one unique vector corresponding to the at least one unique value; and
acquiring the at least one third feature by projecting the at least one second feature onto the at least one unique vector.

4. The method of claim 1, wherein the set dimension is determined based on a similarity between the source domain and the target domain.

5. The method of claim 4, wherein when the similarity between the source domain and the target domain is below or equal to a set degree, the set dimension is adjusted to be less than a set value.

6. The method of claim 1, wherein the acquiring of the at least one third feature comprises using an artificial intelligence model.

7. The method of claim 1, wherein the selecting of the target model comprises:
computing, using a predetermined calculation for calculating a diversity of a feature, a first value representing a diversity of the at least one first feature;
computing, using the predetermined calculation, a second value representing a diversity of the at least one third feature; and
selecting the target model based on the first score calculated using the first value and the second value.

8. The method of claim 7, wherein the first score is obtained by dividing the second value by the first value.

9. The method of claim 7, wherein the first value is variance of a first matrix formed of the at least one first feature, and
wherein the second value is variance of a second matrix formed of the at least one third feature.

10. The method of claim 1, wherein the at least one piece of first data and the at least one piece of second data comprise unlabeled data.

11. The method of claim 1, further comprising:
identifying, for each model in a model set, a second score representing a model performance based on the first data set;
determining resource information required for training the each model in the model set; and
selecting the one or more models among the models in the model set based on the second score and the resource information.

12. The method of claim 11, wherein the one or more models include a model with the second score being greater than or equal to a set value.

13. The method of claim 1, further comprising:
identifying task information on a task to be performed at a user terminal and resource information on a resource available in the user terminal; and
selecting at least a subset of models from a model set to be the one or more models based on the task information and the resource information.

14. The method of claim 1, further comprising tuning a parameter of the target model based on the second data set.

15. The method of claim 10, wherein a third data set associated with the target domain includes labeled data, and
wherein tuning a parameter of the target model is based on the third data set.

16. The method of claim 1, wherein the at least one first data includes a set first number of data pieces from the first data set, and
the at least one second data includes a set second number of data pieces from the second data set.

17. A non-transitory computer-readable recording medium storing a program executable by a computer to perform the method of claim 1.

18. An electronic device for selecting a model, the electronic device comprising:
one or more processors; and
a memory storing instructions that, when executed by the one or more processors, configures the one or more processors to:
identify one or more models trained using a first data set, the first data set associated with a source domain and a second data set associated with a target domain;
for each of the one or more models, acquire at least one first feature corresponding to at least one piece of first data from the first data set and acquire at least one second feature corresponding to at least one piece of second data from the second data set;
acquire, based on the at least one first feature, at least one third feature with a set dimension corresponding to the at least one second feature; and
select a target model from the one or more models based on a first score calculated using the at least one first feature and the at least one third feature.

19. The device of claim 18,
wherein the one or more processors are further configured to acquire the at least one third feature by performing a principal component analysis on a matrix formed of the at least one first feature.

20. A method for selecting a model in an electronic device, the method comprising:
identifying task information on a task to be performed at a user terminal and resource information on a resource available in the user terminal;
determining, based on the task information and the resource information, one or more models in a model set formed of models trained based on a first data set associated with a source domain;
identifying the first data set and a second data set associated with a target domain, wherein the first data set includes first unlabeled data from the source domain and the second data set includes second unlabeled data from the target domain; and
selecting a target model from the one or more models based on the first unlabeled data and the second unlabeled data.
